(19) United States
(12) Patent Application Publication
(10) Pub. No.: US 2007/0068333 A1
(43) Pub. Date: Mar. 29, 2007

(54) Flat handlebar grips

(75) Inventor: Ken Hunter, Fremont, CA (US)

Correspondence Address: QUINE INTELLECTUAL PROPERTY LAW GROUP, P.C., P O BOX 458, ALAMEDA, CA, 94501, US

(73) Assignee: Ken Hunter Design Inc.

(21) Appl. No.: 11/511,866

(22) Filed: Aug. 28, 2006

Related U.S. Application Data
(60) Provisional application No. 60/712,868, filed on Aug. 30, 2005.
(60) Provisional application No. 60/753,232, filed on Dec. 21, 2005.

(51) Int. Cl. B62K 21/26

(52) U.S. Cl. 74/551.9

(57) ABSTRACT

This invention provides handlebar grips with an ergonomic flattened grip cross section. The grips can be rotatably mounted to the inside of handlebar tubes, e.g., for a choice of grip angles and to act as throttle grips for motorized vehicles.

### CROSS-REFERENCE TO RELATED APPLICATIONS

This application claims priority to and benefit of a prior U.S. Provisional Application No. 60/753,232, Flat Handlebar Grips, by Ken Hunter, filed Dec. 21, 2005; and claims priority to and benefit of a prior U.S. Provisional Application No. 60/712,868, Flat Handlebar Grips, by Ken Hunter, filed Aug. 30, 2005. The full disclosure of the prior application is incorporated herein by reference.

### FIELD OF THE INVENTION

The present invention is in the field of hand grips for vehicle steering mechanisms that include handle bars.

### BACKGROUND OF THE INVENTION

Typical handlebars for steering wheeled vehicles include hand grips that are cylindrical in shape. This is apparently because most current handlebars are fabricated from cylindrical tube steel stock and cylindrical grips mount easily over the ends of these handlebars. The style has been traditional since handlebars were made of wood. See, for example, U.S. patent number D323,280, Handlebar Grip, to Chen. Although this design can have some economies and has the same feel from all angles, the straight cylindrical shape can have the disadvantage of ergonomic discomfort; e.g., fitting the hand poorly. More seriously, certain hand grips can place pressure on hand nerves and blood vessels, thus promoting conditions such as poor blood circulation and carpal tunnel syndrome.

Attempts have been made to provide stylish designs for hand grips or to provide grip sections conforming better to the topology of a human grip. See, e.g., U.S. design patent number D331,183, Grip for Bicycles, Motorcycles or the Like, to Henson. However, many of these grips have shapes so complex and unique that they fail to fit well with many people. Such grips require the vehicle rider to hold the handlebars at a particular angle resulting in fatigue and discomfort.

In view of the above, a need exists for hand grips that have a simple ergonomic shape. It would be desirable to have handlebar grips that can be grasped comfortably from a variety of angles. The present invention provides these and other features that will be apparent upon review of the following.

### SUMMARY OF THE INVENTION

The present invention includes various handlebar grips that include features, such as, e.g., a flattened oval grip cross-section and a mount inside the handlebar tube. The grips can be used with handlebar steered vehicles of any kind, such as, e.g., motorcycles, bicycles, mobility devices for disabled persons, snow mobiles, jet skis, and the like.

In one embodiment, the handlebar grip has a grip body with a long axis and a cross section perpendicular to the long axis having an aspect ratio of more than about 1.5, 2, 3 or more. The ergonomic grip body provides a rider of with improved comfort or leverage over a similar grip with a lesser cross section aspect ratio.

In another embodiment, the handlebar grip includes a grip body having a long axis, a cross section perpendicular to the long axis, a cylindrical mounting end, and a hand grip section. A compression mount device is functionally associated with the mounting end of the grip body which has a cross section aspect ratio of 2 or more.

In a particular embodiment, the flat handlebar grip is a throttle grip for a vehicle handlebar. The throttle grip includes a throttle grip body comprising: a long axis, a cross section perpendicular to the long axis, a cylindrical mounting end, and a hand grip section. A proximal portion of the hand grip section comprises a throttle interface that can interact with a throttle of a motorized vehicle on which the throttle grip is mounted. The mounting end is adapted to be rotationally mounted within an axial cavity of the handlebar and has a grip body cross section with an aspect ratio of 2 or more. This configuration can provide comfortable and ergonomic engine power control through turning of the grip.

In a preferred embodiment of mounting the throttle grip into a vehicle handlebar, the grip includes a pair of bearings (e.g., bushings, bearings with races, etc.) mounted along the cylindrical mounting end. The bearings can be separated at opposite ends of the grip body mounting end and include a low friction contact interface between the inner bearing and outer mounting end surface. The bearings can be separated, e.g., by one or more clips (e-clips, c-clips), o-rings or spacer bushings.

Flat handlebar grips for a motorcycle can include a clutch side and a throttle side grip mounted to the motorcycle handlebars. For example, a motorcycle handlebar can comprise: a handlebar cylindrical tubular cross member with a first end with an axial cavity adapted to functionally receive a first grip body mounting end, and a second end with an axial cavity adapted to functionally receive a throttle grip body mounting end. The first grip body (e.g., clutch side grip) can include a long axis, a cross section perpendicular to the long axis, a cylindrical mounting end, a compression mount device functionally associated with the mounting end, and a hand grip section cross section having an aspect ratio of 2 or more. The throttle grip body can include a long axis, a cross section perpendicular to the long axis, a cylindrical mounting end, a throttle control interface, and a hand grip section with a cross section aspect ratio of 2 or more. Such a configuration allows for fixed but adjustable clutch side flat bar angles and a freely rotatable flat bar throttle control for a motorcycle.

The handlebar grips can be mounted with a compression mount device that frictionally binds the grip cylindrical mount in the handlebar tube. For example, the compression mount device can be a split bushing, a frictional resilient plug, rubber or thermoplastic elastomer plug, and the like.

In a preferred embodiment, the handlebar grips can be mounted inside the vehicle handlebar with diameter adjustment using wrappings of tape. For example, rotational bearings of a throttle grip can be wrapped with tape to approximate the inner diameter of the handlebar tube inner circumference. Optionally, tape can be wrapped about the outer surface of a grip body mounting end to approximate the inner circumference diameter of the handlebar tube. With the mounting end or throttle bearing thus wrapped, little or no space remains between the mounting end and handlebar inner walls, thus reducing grip movement lateral to the grip long axis. In preferred embodiments, the tape includes an adhesive on at least one side to attach the tape to the grip and/or to hold the tape in the wrapped condition. In preferred embodiments, the tape comprises a foam, such as a fine urethane foam, to provide, e.g., a resilient fit and to reduce transmission of vibrations from the handlebar to the grip.

The throttle interface can be adapted to any particular throttle mechanism. For example, the interface can include set screws to mount the throttle grip to a throttle rotor. For many embodiments of throttle grips, the proximal end of the mounting end can include a low friction bushing and/or low friction alignment o-ring.

The hand grip section can include a thumb indent for more ergonomic positioning of the riders thumb on the grip. In some embodiments, the thumb indent of the hand grip section has an aspect ratio at least 25% lower than a distal end of the hand grip section.

The various embodiments can feature different components and functional aspects. For example, the cylindrical mounting end can be adapted for insertion into an end of a cylindrical or polygonal cross-section tubular handle bar of the vehicle. The long axis of the grip body can range in length form about 4 inches to about 12 inches, or measure about 8 inches. The grip section cross-section can have an aspect ratio ranging from about 1.5 to about 10; about 2, about 3, or about 4. In certain embodiments, the thickness of the grip section can be less than the outer diameter of the associated handlebar tube. The grip bodies can be cast metal and can be covered with resilient grip covers mounted over the hand grip sections. The grip can have materials and dimensions adequate to withstand a force of 150 ft-lbs or more across the long axis without breaking. The grip can be mounted, as described herein, to be rotated around the long axis with hand pressure (e.g., about 20 ft-lb to about 10 ft-lb) but not pulled out from the handle bar with a force of 200 pounds, 100 pounds or 50 pounds.

### DEFINITIONS

Unless otherwise defined herein or below in the remainder of the specification, all technical and scientific terms used herein have meanings commonly understood by those of ordinary skill in the art to which the present invention belongs.

Before describing the present invention in detail, it is to be understood that these inventions are not limited to particular devices, methods or systems, which can, of course, vary. It is also to be understood that the terminology used herein is for the purpose of describing particular embodiments only, and is not intended to be limiting. As used in this specification and the appended claims, the singular forms “a”, “an” and “the” include plural referents unless the content clearly dictates otherwise. Thus, for example, reference to “a component” can include a combination of two or more components; reference to “material” can include mixtures of materials, and the like.

Although many methods and materials similar, modified, or equivalent to those described herein can be used in the practice of the present invention without undue experimentation, the preferred materials and methods are described herein. In describing and claiming the present invention, the following terminology will be used in accordance with the definitions set out below.

As used herein, the term “aspect ratio” refers to a ratio between the longest diameter (perpendicular to the long axis) of a grip section cross-section and the perpendicular diameter half way along the length of the grip section.

The term “compression mount”, as used herein, refers to a mount that binds to grip the inner surface of a tube by expansion radially to forcefully contact the surface. For example, typical compression mounts include split bushing types and types employing compression of resilient materials.

As used herein, a “tubular handlebar” is a handlebar for steering a vehicle in which the handlebar has a central cavity running in axially at least 2 inches from at least one end of the handlebar. Many tubular handlebars are known in the art, such as, e.g., most bicycle and motorcycle handlebars.

### BRIEF DESCRIPTION OF THE DRAWINGS

FIG. 1 is a schematic diagram of a grip body.

FIG. 2 is a schematic diagram of a handlebar grip including a compression mount.

FIG. 3 is a schematic diagram of a flat throttle grip.

FIG. 4 is a schematic diagram of a grip with a thumb indent.

FIG. 5 is a schematic diagram of a clutch side grip.

FIG. 6 is a schematic diagram showing exploded clutch side grip components.

FIG. 7 is a schematic diagram of a flat throttle grip.

FIG. 8 is a schematic diagram showing exploded throttle grip components.

FIG. 9 is a schematic diagram of a flat grip including tape wrapping or a resilient bushing to eliminate space between the grip body mounting end and the inside of the handlebar.

FIG. 10 is a schematic diagram showing a throttle grip with two low friction rotation bushings.

### DETAILED DESCRIPTION

Handlebars are used in steering of many types of vehicles. Handlebars provide leverage for one or both hands of a rider to turn a steering wheel, jet, propeller, rudder, ski, etc., and thus direct the travel of the vehicle. Handlebar grips are typically provided on the ends of handlebars, e.g., to provide a more secure grip for the rider. Handlebars are commonly found on many vehicles, such as, e.g., motorcycles, bicycles, jet skis, carts for disabled persons, snow mobiles, and the like.

The handlebar grips of the present invention have, e.g., a simple flattened oval or generally rectangular cross-section that is simple, yet comfortable, for riders having a wide variety of hand sizes and shapes. The minimum cross sections of the grips are typically not dictated by the cross section to the handlebar, to which they are mounted. Many handlebar grips of the invention provide rotatable surfaces to offer readily adjustable angles for gripping. In particular embodiments of the invention, the grips can be mounted to the inside of tubular handlebars for a strong rotatable throttle grip compatible with many new or retrofit applications.

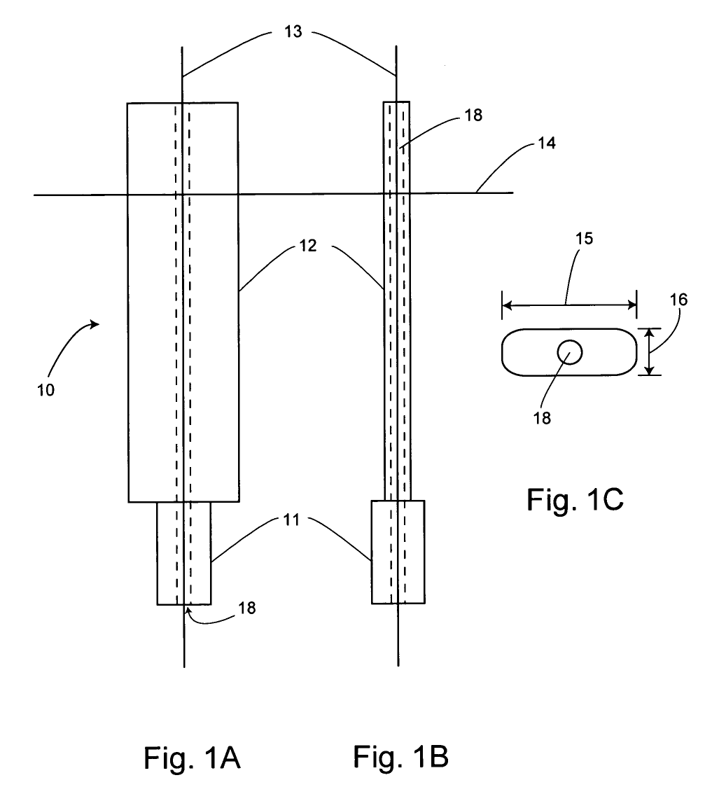

Handlebar grips of the invention generally include, e.g., a grip body 10 with a cylindrical mounting end 11 and a hand grip section 12 that share a common long axis 13, as shown in FIG. 1 (A and B are views presented at 90° from each other). The mounting end of the grip body can typically be rotatably mounted inside in a tubular handlebar with the hand grip section extending out from the end of the handlebar, where it can be grasped by a rider. When viewed through in cross-section 14 perpendicular to the long axis, the grip section can appear as, e.g., an elongate oval or rectangle with an aspect ratio (width 15 to depth 16) of greater than 2. It can be seen, e.g., in FIG. 1B that a cross section dimension of the grip section can be less than the outer diameter of the mounting end (e.g., less than the inner diameter of the handlebar tube).

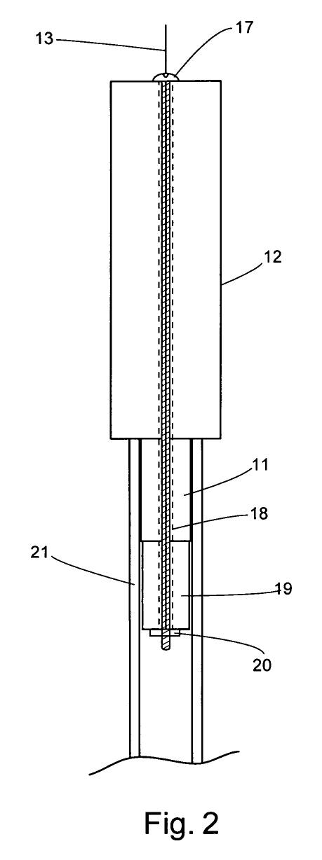

For many applications, the handlebar grip can additionally include a compression mount device, e.g., extending beyond the cylindrical mounting end. A long cap screw 17 can be inserted through an axial hole 18 running through the handlebar grip and the compression device 19, as shown in FIG. 2. A keep nut 20 can be attached to the threaded end of the screw to hold the pieces together before inserting the mounting end and compression device into the end of a tubular handlebar 21. By tightening the cap screw onto the keep nut the compression mount is compressed and tends to expand out against the inside walls of the handlebar to form a strong frictional mount that withstands forces that may try to pull the grip out of the handlebar. An adhesive disc can be included between the compression mount and keep nut to retain the nut if it becomes disengaged from the screw to keep it from coming completely off of the bolt.

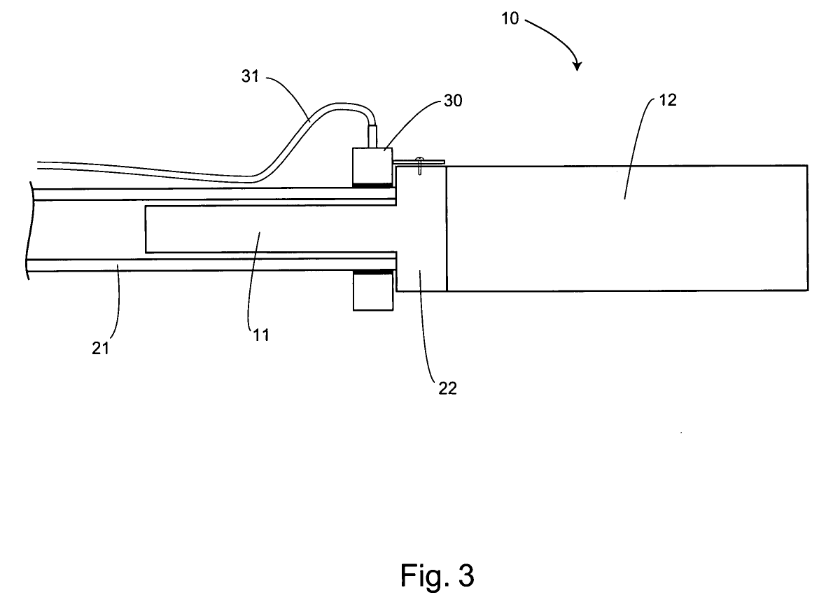

For certain motorized vehicles, it can be desirable to have the grip body rotatable about the long axis and functionally associated with a throttle control. In many cases, the handlebar grip, mounted as described above, can pivot about the long axis, even though it cannot be pulled from the handlebar tube cavity. The grip body can be associated with a throttle control, e.g., at the throttle rotor, so that motor power and cruising speed can be set by turning the grip body. In other embodiments of throttle grips, the cylindrical mounting end 11 of the grip body 10 can be inserted into the handlebar tube 21, as shown in FIG. 3. The proximal portion of the grip section can be a throttle interface 22, between the mounting end and the hand grip section. The throttle interface can functionally interact with a throttle control 30, e.g., to control an engine throttle through a throttle cable 31 to control engine power. The throttle interface can be mounted to the handlebar tube and attached to the proximal (inner) portion so that the grip body is allowed to rotate about the long axis (i.e., rotationally mounted) but prevented from moving out of the handlebar tube.

In embodiments for motorcycles, and the like, a handlebar can include a flat bar grip on one end and a flat throttle grip on the other end. For example, the left (typically clutch side) end of the handlebar can have a first grip body mounted into its bore using a compression mount; the right (typically throttle side) end can have a throttle grip body rotatably installed with the cylindrical mounting end in the tube bore, but with a throttle interface functionally attached to a throttle control mechanism.

Grip Bodies

Grip bodies of the invention generally have a flattened hand grip section and a cylindrical mounting end, as described above. The mounting end is inserted into the bore of a handlebar for mounting, as compared to the standard practice of mounting hand grips to the outside of handlebars. This unique feature allows design of the hand grip section without regard to the dimensions of the handlebar tube to which it is mounted. For example, the hand grip section of the invention is not required to follow the axis of a handlebar tube support and can have a least structural cross-section diameter less than the handle bar tube to which it is mounted. Various accessory components can be combined with the grip bodies for use in particular situations.

Grip bodies can be made from any appropriate materials, e.g., having the strength and durability required for particular applications. For example, the grip bodies can be fabricated from a plastic, a metal or a composite. In a preferred embodiment, they are cast from 356T6 aluminum or machined from 5051-T6 aluminum. It is preferred the grip bodies be strong enough to withstand toppling of the vehicle. For example, the mounted grip bodies should be able to withstand a force at the outer end of the hand grip section of at least 20 ft-lb, 50 ft-lb, 100 ft-lb, 150 ft-lb, 200 ft-lb, or more. Grip bodies withstanding the force will not be broken, cracked or permanently bent by the force. In a preferred embodiment for motorcycle applications, the grip body can withstand at least 150 ft-lb.

Grip bodies can optionally be mounted in handlebars with compression mount devices, such as, e.g., split bushings or compressible resilient plugs. For example, the compression mount can be a diagonally split bushing similar to those commonly used to mount bicycle handlebar shafts into front forks. As with many compression mounts, a long bolt (cap screw) runs through to a nut on the back side of the mount to apply compressive force that expands the mount out radially into the inner handlebar tube wall. For diagonal split bushings, pressure from the nut pushes an inner bushing section into an outer bushing section along a diagonal (to the long axis) contact surface so that as the diagonal surfaces slide past each other, pushing each other aside to bind within the tube inside cavity. In a similar design, a bushing split parallel to the long axis is capped with a nut presenting a conical face. As the nut is forced into the bushing (by turning of the cap screw) the two sides of the split bushing are forced apart by the conical face into the tube walls. In a preferred embodiment, the compression mount is a cylinder of deformable (typically incompressible, i.e., substantially unchanged in volume in response to forces) material that fits into the handlebar tube between the nut and cylindrical mount of the grip body. The cap screw runs through an axial hole in the deformable cylinder to the nut for compression and binding when the screw is turned.

Grip bodies include a mounting end that is inserted into the vehicle handlebar for mounting the handlebar grips. In preferred embodiments, the mounting ends conform to the interior space of the handlebar tube. For example, if the handlebar tube has a square cross-section, the mounting end can have a complimentary square cross-section. However, in preferred embodiments, the mounting end has a circular cross-section, so that, e.g., the grip can rotate without conflicting with the handlebar inner walls. The outer diameter of the mounting end can be slightly less than the inner diameter of the handlebar tube, e.g., so it can be inserted and rotate freely. The mounting end of the grip body can have a diameter (measured perpendicular to long axis) ranging from less than ¼ inch to more than 2 inches, from about 1.25 inches to about 0.5 inches, from about 1 inch to about 0.75 inches, or about ⅞ inches. The mounting end of the grip body can have a length (measured axially) ranging from less than an inch to more than a foot, from about 8 inches to about 2 inches, from about 6 inches to about 3 inches, or about 4 inches. In many cases, a low friction sleeve (e.g., engineering plastic bushings, polyfluorocarbon, Delrin™, etc.) can be located between the mounting end outer surface and the handlebar inner surface, to reduce friction and wear between metal surfaces. Optionally, a low friction alignment o-ring can be mounted, e.g., between two clip rings retained in annular slots in the mounting end, to space the mounting end outer surface from the tube inner surface and to provide a bearing surface for smooth rotation of the grip in the tube.

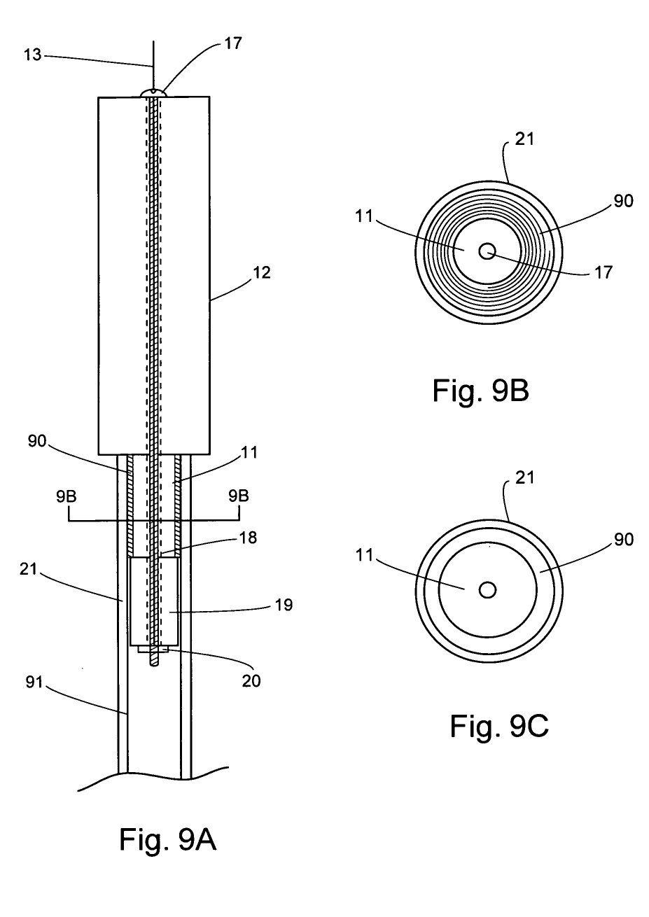

In an exemplary embodiment of a grip mount, the outer diameter of the mounting end is adjusted out with a wrap of tape or resilient sleeve. For embodiments using tape, the diameter of the mounting end can effectively be increased so that, when mounted within a handlebar tube, there is little or no clearance between the tape of the grip and the inner surface of the tube. For example, as shown in FIG. 9, a sleeve or spiral of tape 90 is wrapped around the outer surface of the grip body mounting end 11 so that the tape contacts the inner wall surface 91 of the handlebar 21 leaving little or no space between the mounting end and the handlebar inner wall. Optionally, a resilient sleeve can be substituted for the wrap of tape, as shown in FIG. 9C (exaggerated in thickness over typical embodiments for viewing clarity). The tape or sleeve can have an adhesive coating on one or both sides to help fix the tape to the mounting end and/or to retain the tape in a tightly wound configuration. The tape or sleeve can be any appropriate type, e.g., comprising plastic, fiber or foam. In a preferred embodiment the tape includes a layer of fine closed cell polyurethane foam, e.g., to provide a resilient fit and help reduce transmission of vibrations between the handlebar and grip.

Grip bodies include a hand grip section extending from the handlebar tube end when installed. This is the part of the grip body grasped by the hand of vehicle rider when in use. The cross-section (perpendicular to the long axis) of the hand grip section can be longer in one direction than another. For example, the cross-section can generally describe an oval, a long triangle or a rectangle, or other elongate or flattened shapes. In preferred embodiments, the cross-section of the grip body grip section can have an aspect ratio (ratio of the longest dimension to the perpendicular dimension, e.g., at the longest dimension mid point) of about 1.5 or greater. In preferred embodiments, the aspect ratio can range from about 2 to more than 10, from about 3 to about 5, or about 4. The aspect ratio can be different at different points along the long axis, or remain about the same (where the aspect ration changes, the aspect ratio of the hand grip section can be calculated as the average aspect ratio along the long axis). The hand grip section can comprise a resilient padded or compressible surface material to increase comfort and reduce transfer of vibration from the handlebars to the hand. Optionally, the grip sections can be overlaid with a resilient grip covers (the contribution of the cover to the hand grip dimensions can be considered or not considered in calculation of aspect ratios).

In another aspect of the invention, the least diameter of the grip section can be less than the diameter of the handlebar tube to which the grip body is mounted. In this way grip section dimensions are not dictated by the axis and diameter of the handlebar tube, as are prior art hand grips. This can allow for smaller diameter grips for persons and children having smaller hands. This can allow for flattened grip sections with a least cross-section diameter less than the associated handlebar tube. This can allow turning of a grip section wherein the axis of the grip is not constrained to remain concentric or parallel to the central axis of the associated handlebar tube.

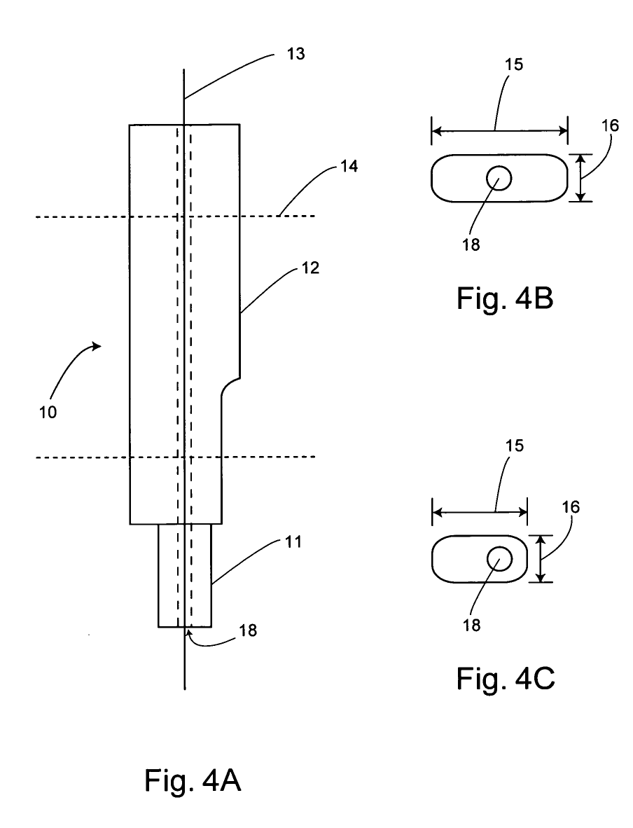

In a preferred embodiment, there is a thumb indent provided at the section of the hand grip section near the mount end. The thumb indent can be a recess in one edge of the hand grip section, as shown in FIG. 4. In some embodiments, the longest dimension can be shorter at the thumb indent cross-section 40 (FIG. 4C) than the cross-section 41 (FIG. 4B) at the part of the hand grip intended to be grasped by the palm and fingers. The thumb indent can have an aspect ration different from the rest of the hand grip section. For example, the thumb indent can have an aspect ratio of about 1, 1.5, 2, 3, or more, while the rest of the hand grip section has an average aspect ratio at least 0.5 more.

Grip bodies for throttle grips can have an interface with a throttle, e.g., so turning the throttle grip can control engine power. The throttle interface can be configured to suit any particular application. For example, where the throttle cable runs inside the handlebar, the throttle interface can be located at the mounting end and have a ramped surface that pulls and releases the cable as the grip is turned. For many motorized vehicles, the throttle control has a throttle rotor that spools a throttle cable in and out to control engine power. In such a case, a throttle interface can be a portion of the grip body adjacent to the throttle rotor in functional contact to turn the rotor when the grip is turned. The contact between the throttle interface and the throttle can further provide a means to prevent the mounting end from being pulled out from the handlebar. The throttle rotor can be a cylindrical flange extending from the throttle control and the throttle interface can be a cylindrical section (e.g., between the mount end and grip section) that fits within the rotor. The rotor and interface can be attached using set screws running through a flange of the rotor to seat into the interface. In a preferred embodiment, the interface has threaded holes to receive screws passing through the rotor. The holes in the interface can be spaced to receive multiple screws for strength and offer a selection of mounting angles (e.g., every 45 degrees). Optionally, the holes in the rotor flange can be larger than the shaft of the screw or slotted to allow a selectable range of grip mounting angles. The grip angle can be selected to provide maximum comfort or function while riding the vehicle, e.g., an angle that provides cruise power when the rider's wrist is at the most comfortable position.

Using Flat Handlebar Grips

Flat handlebar grips can provide a comfortable and ergonomic grip for use on any vehicle steered with handlebars. The grips can be mounted to the vehicles in the factory or added to vehicles through the aftermarket. The grips can be fixedly secured to handlebars, or rotatably mounted to allow selection of grip positions and use in control devices.

Flat handlebar grips can provide enough leverage to function as a clutch control. For example, the grips can interface with a cable spooling rotor (in a fashion similar to the description of the throttle interface) to pull a clutch cable and release a motor-scooter clutch when the grip is turned.

The flat bar grips can be mounted fixed immobile to the inside of a handlebar tube. The grips can be oriented for best comfort and fixed with a compression mount, as described above. Alternately, the mounting ends can be mounted by other means, such as, e.g., using polymerizable resins or set screws through the handlebar.

The flat bar grips can be installed as a retrofit. For example, the original equipment grips can be removed and the flat handlebar grips mounted in the bar tubes. Typically, the handlebars are cut off at a length that presents the grips at a distance from the steering pivot that the rider finds comfortable and functional.

Flat handlebar grips are suitable for a variety of vehicles. The grips of the invention can be used on vehicles on the land, sea and air. Exemplary vehicles, that can benefit from flat bar grips include, e.g., motorcycles, bicycles, mobility devices for disabled persons, snow mobile, jet skis, and the like.

### EXAMPLES

The following examples are offered to illustrate, but not to limit the claimed invention.

### Example 1

### Variable Angle Flat Handlebar Grip

Clutch side flat handlebar grips were manufactured with features including a thumb indent, a low friction sleeve, a foam rubber grip cover, and a rubberized compression mount device.

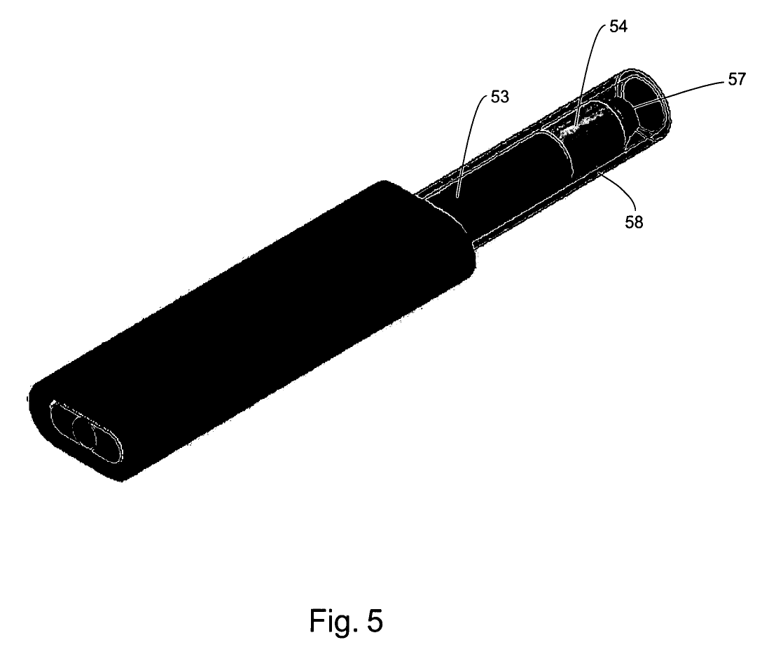

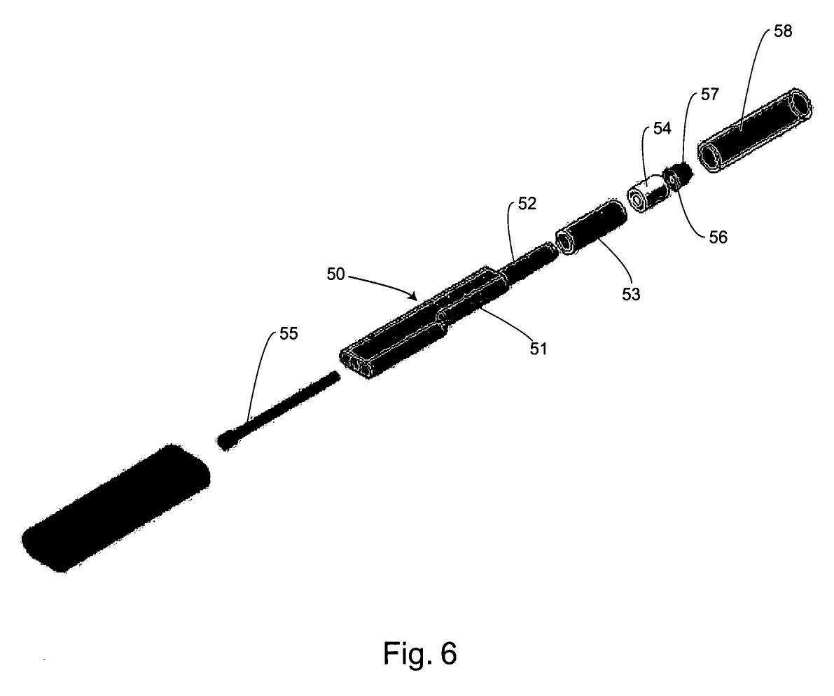

The 7-inch long grip body 50 was cast from 356T6 aluminum and a central hole was drilled along the long axis, as shown in FIGS. 5 and 6. The grip body was capable of withstanding a force of 150 ft-lb without damage. The grip section included a thumb indent 51 along one inner side of the grip section. The aspect ratio of the outer grip section (finger grip) was about 3.75, while the aspect ratio of the indent region was about 3. The cylindrical mounting end 52 was about 2 inches long and about ¾ inch in outer diameter. An engineering plastic bearing 53 was placed over the mounting end to aid in rotation of the grip in a handlebar tube. A foam rubber cover over the grip section provided a resilient grip and an overall aspect ratio of about 2.6. Note that the minimum thickness of the grip section, with or without a foam rubber cover, is less than the diameter of the handlebar tube 58.

The compression mount device 54 was a plug or cylinder of SANTOPRENE™ material with an axial through hole. The mount device was about 1 inch long and about ¾ inch in diameter. Santoprene was chosen for its high friction coefficient and incompressibility (little or no volume change in response to force). The resilient plug style compression device was found to provide a significant reduction in vibration transmission from the handlebar to the hand.

To mount the clutch side flat bar grip into the left handlebar of a KAWASAKI CONCOURSE™, about 6 inches of the original handlebar was removed with a hack saw. A 4-inch cap screw 55 was inserted through the grip body, the mount device, a plastic disk 56 with pressure sensitive adhesive on both sides, and threaded loosely onto keep nut 57. The assembly was inserted into the cut end of the handlebar 58 with the nut first until the cylindrical mount was entirely within the bore of the cut handlebar tube. The cap screw was turned further into the keep nut causing a clamping force that compressed the components along the long axis. The compression caused the compression mount device to bulge out to forcefully contact the inner surface of the handlebar tube.

Inspection of the mounted grip found that although the grip could be turned with moderate force about the long axis (e.g., to change the grip angle), it could not be pulled from the handlebar tube with large forces (e.g., 200 lbs). This may be because additional pulling along the cap screw causes additional compression of the compression device that increases the holding strength. Meanwhile, the grip section could be turned to any desirable position for comfort and variety of grasping.

### Example 2

### Flat Handlebar Throttle Grip

Throttle side flat handlebar grips were manufactured with features including a thumb indent, a low friction sleeve, a foam rubber grip cover, an alignment o-ring, and a throttle interface.

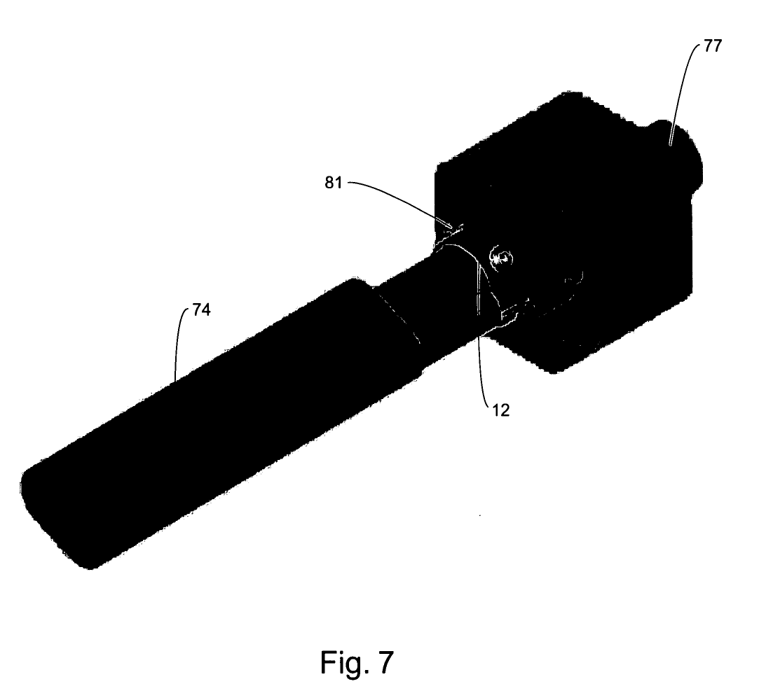

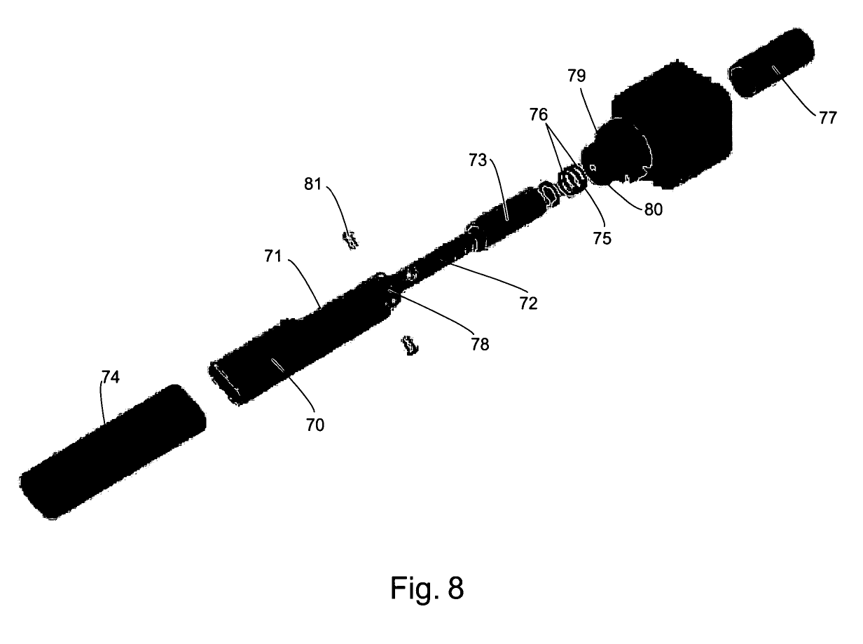

The 8-inch long grip body 70 was cast from 356T6 aluminum. C-clip receiving groves and interface threaded holes were machined into the grip body, as shown in FIGS. 7 and 8. The grip body was capable of withstanding a force of 150 ft-lb across the axis without damage. The grip section included a thumb indent 71 along one inner side of the grip section. As with the clutch side grip, the aspect ratio of the outer (distal) grip section (finger grip) was about 3.75, while the aspect ratio of the inner (proximal) indent region was about 3. The cylindrical mounting end 72 was about 3 inches long and about ¾ inch in outer diameter. A plastic bearing 73 was placed over the mounting end to aid in rotation of the grip in a handlebar tube. A foam rubber cover 74 over the grip section provided a resilient grip and an overall aspect ratio of about 2.6.

To mount the throttle side flat bar grip into the right handlebar of the motorcycle, about 6 inches of the original handlebar was removed with a hack saw. The throttle grip was assembled by pushing on the resilient cover, sliding the plastic bearing over the mounting end, an then mounting an alignment o-ring 75 of DELRIN™ between E-clips 76. The assembly was inserted into the cut end of the handlebar 77 until the throttle interface 78 slid inside the throttle rotor flange 79 (part of the motorcycle original equipment). Holes 80 had been drilled in the flange for passage screws 81 to be received by threaded holes in the throttle interface. When a desired grip angle was selected, the screws were inserted through the flange holes and threaded into the interface holes to fix the grip to the throttle rotor.

Inspection of the mounted grip showed the grip could be turned with easy force about the long axis and it was retained in the handlebar tube by its association with the throttle rotor. The motorcycle could be operated with throttle control by turning the hand grip. Tipping of the motorcycle from kickstand position to the ground did not damage the grip body.

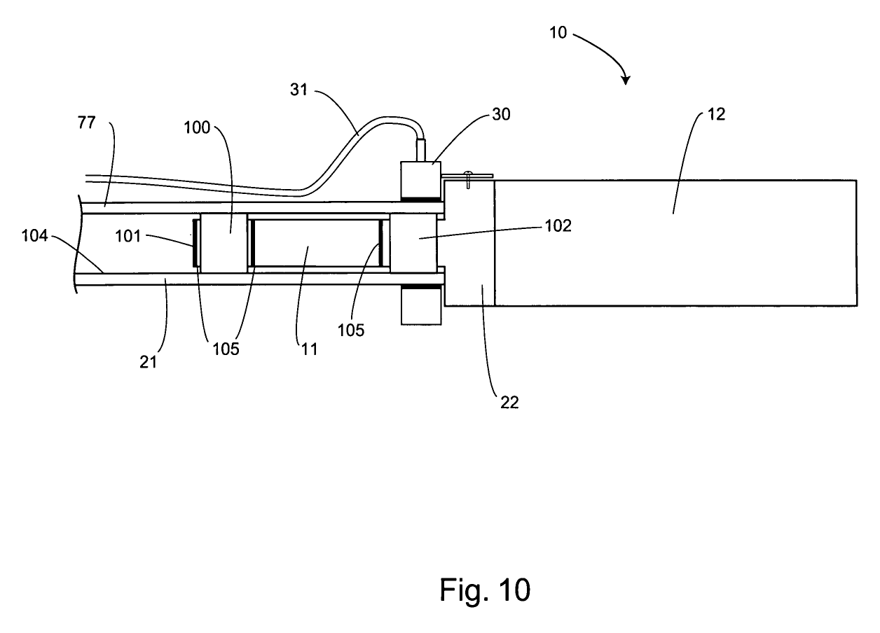

In an alternate embodiment of the throttle grip mount, instead of a single bushing 73, the mounting end 72 can be provided with two or more separate bushings. For example, as shown in FIG. 10, a pair of bushings can be used to rotatably locate the mounting end within the handlebar tube. A first bushing (e.g., any type of bearing) 100 can be placed at or near the inner end 101 of the mounting end and a second bushing 102 placed at or near the outer section 103 of the mounting end. The bushings can turn freely in a low friction contact with the mounting end and/or the inner surface wall 104 or the tube. The bushings can be prevented from migration along the axis of the mounting end by retaining clips 105. Optionally a spacer bushing can be located between the first and second bushing, e.g., to keep them spaced from each other. In preferred embodiments, the bushings are wrapped with a sleeve or tape to reduce or eliminate space between the bushing outer surface and the handlebar inner surface. Such wrapping can reduce wobble of the mounting end within the handlebar tube and reduce transmission of vibrations, as discussed above.

It is understood that the examples and embodiments described herein are for illustrative purposes only and that various modifications or changes in light thereof will be suggested to persons skilled in the art and are to be included within the spirit and purview of this application and scope of the appended claims.

While the foregoing invention has been described in some detail for purposes of clarity and understanding, it will be clear to one skilled in the art from a reading of this disclosure that various changes in form and detail can be made without departing from the true scope of the invention. For example, many of the techniques and apparatus described above can be used in various combinations.

All publications, patents, patent applications, and/or other documents cited in this application are incorporated by reference in their entirety for all purposes to the same extent as if each individual publication, patent, patent application, and/or other document were individually indicated to be incorporated by reference for all purposes.

What is claimed is:

1. A handlebar grip for a vehicle, the grips comprising:
a long axis; and,
a cross section perpendicular to the long axis, the cross section comprising an aspect ratio of 3 or more;
thereby providing a rider of the vehicle with improved comfort or leverage over a similar grip with a lesser cross section aspect ratio.

2. The grip of claim 1, mounted to a handlebar tube, and wherein a least diameter of the grip cross section is less than an outer diameter of a handlebar tube to which it is mounted.

3. The grip of claim 1, wherein the vehicle is selected from the group consisting of: a motorcycle, a bicycle, a mobility device for disabled persons, a snow mobile, and a jet ski.

4. The grip of claim 1, wherein the grip further comprises a cylindrical mounting end adapted for insertion into an end of a cylindrical tubular handle bar of the vehicle.

5. The grip of claim 1, wherein the long axis comprises a length of 8 inches or more.

6. The grip of claim 1, wherein the cross section comprises an aspect ratio of 4 or more.

7. The grip of claim 1, wherein the grip withstands a force of 150 ft lbs or more across the long axis.

8. The grip of claim 1, further comprising a clutch control in functional association with a clutch or a throttle interface in functional association with a throttle control.

9. A handlebar grip for a vehicle, the grip comprising:
a grip body comprising: a long axis; a cross section perpendicular to the long axis; a cylindrical mounting end; and a hand grip section; and,
a compression mount device functionally associated with the mounting end;
wherein the cross section of the grip body has an aspect ratio of 2 or more.

10. The grip of claim 9, wherein the vehicle is selected from the group consisting of: a motorcycle, a bicycle, a mobility device for disabled persons, a now mobile, and a jet ski.

11. The grip of claim 9, wherein the cylindrical mounting end adapted for insertion into an end of a cylindrical tubular handle bar of the vehicle.

12. The grip of claim 11, wherein the inserted and mounted grip can be rotated about the long axis with hand pressure but not pulled out from the handle bar with a force of 200 pounds or less.

13. The grip of claim 9, mounted to a handlebar tube, and wherein a least diameter of the grip cross-section is less than an outer diameter of a handlebar tube to which it is mounted.

14. The grip of claim 9, wherein the compression mount device comprises: a split bushing, a frictional resilient plug, rubber or thermoplastic elastomers.

15. The grip of claim 9, wherein the cross section comprises an aspect ratio of 3 or more.

16. The grip of claim 9, wherein the grip withstands a force of 150 ft lbs or more across the long axis without breaking.

17. A throttle grip for a vehicle handlebar, the grip comprising:
a throttle grip body comprising: a long axis; a cross-section perpendicular to the long axis; a cylindrical mounting end; and a hand grip section; wherein:
a proximal portion of the grip section comprises a throttle interface;
the mounting end is adapted to be rotationally mounted within an axial cavity of the handlebar; and,
the cross section of the grip body has an aspect ratio of 2 or more.

18. The throttle grip of claim 17, wherein the throttle interface comprises set screws to mount the throttle grip to a throttle rotor.

19. The throttle grip of claim 17, wherein a thumb indent of the hand grip section has an aspect ration at least 25% lower than a distal end of the hand grip section.

20. The throttle grip of claim 17, wherein a least diameter of the grip cross-section is less than an outer diameter of the handlebar.

21. The throttle grip of claim 17, wherein a proximal end of the mounting end comprises a low friction o-ring or bushing.

22. A motorcycle handlebar comprising:
a first grip body comprising: a long axis; a cross section perpendicular to the long axis; a cylindrical mounting end; a compression mount device functionally associated with the mounting end; and, a hand grip section with a cross section comprising an aspect ratio of 2 or more;
a throttle grip body comprising: a long axis; a cross section perpendicular to the long axis; a cylindrical mounting end; a throttle control interface; and, a hand grip section with a cross section comprising an aspect ratio of 2 or more; and,
one or more cylindrical tubular cross members comprising a first end with an axial cavity adapted to functionally receive the first grip body mounting end, and a second end with an axial cavity adapted to functionally receive the throttle grip body mounting end.

23. The handle bar of claim 22, wherein the grip bodies are cast metal, and further comprising resilient grip covers mounted over the hand grip sections.

24. The handle bar of claim 22, wherein the grip bodies can withstand a force of 150 ft-lbs or more across the long axis without breaking.

25. A handlebar grip that is mounted with a mounting end inside a handlebar tube.

26. A hand grip for a vehicle handlebar, the hand grip comprising:
a grip body comprising a hand grip section, wherein a least cross-sectional diameter of the grip section is less than an outer diameter of the handlebar.

27. A throttle grip for a vehicle handlebar, the grip comprising:
a throttle grip body comprising: a long axis; a cross section perpendicular to the long axis; a cylindrical mounting end; and a hand grip section; and,
a first bushing separated from a second bushing along the cylindrical mounting end;
wherein:
a proximal portion of the grip section comprises a throttle interface; and,
the mounting end is adapted to be rotationally mounted within an axial cavity of the handlebar.

28. The throttle grip of claim 27, wherein the first and second bushings are separated by one or more clips, or separated by a spacer bushing.

29. The throttle grip of claim 27, further comprising a resilient sleeve or a tape wrapped around the first bushing or second bushing, thereby adjusting a bushing diameter.

30. The throttle grip of claim 29, wherein the tape or sleeve comprises an adhesive or a foam.

31. The throttle grip of claim 27, wherein the cross section of the hand grip section has an aspect ratio of more than 2.

32. A handlebar grip for a vehicle, the grip comprising:
a grip body comprising: a long axis; a cross section perpendicular to the long axis; a mounting end; and a hand grip section; and,
one or more tapes wrapped around the mounting end, thereby adjusting a diameter of the mounting end to substantially contact an inner circumference of a handlebar tube when the grip is mounted into the handlebar.

33. The grip of claim 32, wherein the tapes comprise an adhesive or a foam.

34. The grip of claim 32, further comprising a compression mount device functionally associated with the mounting end.

35. The grip of claim 32, wherein the cross section of the grip body has an aspect ratio of more than 2.
